(19) United States
(12) Patent Application Publication
(10) Pub. No.: US 2025/0321395 A1
(43) Pub. Date: Oct. 16, 2025

(54) DEVICE AND ARRANGEMENT FOR ALIGNING AN OPTICAL ELEMENT IN AN OPTICAL BEAM PATH

(71) Applicant: Carl Zeiss Microscopy GmbH, Jena (DE)

(72) Inventor: Christoph Eichhorn, Jena (DE)

(73) Assignee: Carl Zeiss Microscopy GmbH, Jena (DE)

(21) Appl. No.: 19/173,998

(22) Filed: Apr. 9, 2025

(30) Foreign Application Priority Data
Apr. 10, 2024 (DE) 10 2024 203 285.9

(51) Int. Cl. G02B 7/00

(52) U.S. Cl. CPC G02B 7/005; G02B 7/006

(57) ABSTRACT

A device aligns an optical element in an optical beam path. The device has a main body which has a free beam passage along a beam axis, wherein the main body can be rotated about the beam axis; a holder for holding the optical element on the beam axis, wherein the holder can be inclined in controlled fashion relative to the beam axis by an angle selected from a predetermined angular range in that by a cam control, which partially or completely encircles the main body and is decoupled from a rotational position of the main body, a current inclination of the holder can be adjusted. An arrangement has such a device and a microscope has such an arrangement.

The invention relates to a device and an arrangement for aligning an optical element in an optical beam path.

If, in an optical beam path, at least one optical element is not just to be adjusted once, but controlled repeatedly so as to change its position and/or alignment, i.e. two-dimensionally or three-dimensionally, in the beam path, multiple drives are necessary. However, the accommodation and actuation of multiple drives (manual mechanical drives, motors) leads to a correspondingly high space requirement.

Examples of space-saving technical solutions can be found in EP 1 643 283 A1, in which an optically effective element is held on an optical axis and can be deflected there about two mutually perpendicular axes of rotation. However, there is still a need for two drives. According to the solution disclosed in US 2018/0217349 A1, an optical element can be adjusted about three axes by means of three drives. WO 2007/038827 A1 describes an option for aligning an optical element which is very demanding in terms of space.

The invention is based on the object of proposing a further option for aligning an optical element in an optical beam path, which reduces the disadvantages that arise in the prior art.

The object is achieved by the subject matter of the independent claim. Advantageous configurations are found in the dependent claims.

The device according to the invention for aligning an optical element in an optical beam path comprises a main body which has a free beam passage along a beam axis. This virtual beam axis can, when the invention is used as intended, coincide with an optical axis of an optical beam path. The main body is rotatable, or can be rotated, about the beam axis. The beam passage can advantageously have a symmetrical, in particular a rotationally symmetrical cross section. To hold the optical element on the beam axis, a holder is present. It can be inclined in controlled fashion relative to the beam axis by an angle which has been, or is, selected from a predetermined angular range. A respective (current) inclination can be adjusted by means of a cam control. The cam control is constructed and arranged such that it partially or completely encircles the main body. It is decoupled from a rotational position of the main body, with the result that a current inclination of the holder is adjusted, or is adjustable, by means of the cam control irrespective of a current rotational position of the main body.

In the context of this description, an optical element is understood to mean a component which has an optical effect (optically effective element) on radiation in a selected wavelength range. An optical effect is in particular (double) refraction, filtering, beam shaping and/or deflection of the radiation.

In an advantageous embodiment of the invention, the optical element may be a plane plate which is transparent to a selected wavelength range. It may be birefringent. A low absorption does not contradict the term “transparency”. A plane plate, for example made of glass, makes it possible to align a beam easily and cost-effectively, as described in more detail later on.

The cam control is advantageously implemented as a cam disc which is for example in the form of a half-ring but is advantageously annular, and has a variable width parallel to the beam axis. The shape of the cam disc specifies which angles of inclination the holder assumes, or can assume. If the holder is correspondingly mounted, the holder can be inclined both clockwise and anticlockwise in relation to an alignment extending orthogonally to the beam axis (angle of inclination of zero). In further embodiments, an inclination is enabled only in one of the two directions. The latter option is sufficient and easier to implement. If the cam disc is additionally in the form of a closed ring, i.e. the inclination of the holder can be adjusted over an angular range of 360°, an inclination to one side allows the same adjustment options as an ability to tilt to two sides does.

In further configurations of the invention, the cam disc can be interchangeable, with the result that the device can be equipped either in the factory or by a user with variously shaped cam discs.

The core of the invention is both the ability to tilt the holder, together with the optical element, irrespective of a current rotational position of the main body, and the shaping of the cam control used for this such that it partially or completely encircles the main body. This allows a maximum range of possible combinations of rotational positions of the main body and inclinations of the optical element combined with a low structural space requirement.

The holder is in mechanical contact with the cam control, in particular with a control cam of the cam control. In order to be able to secure continuous contact of the cam control by the holder, for example via an actuating lever, a compression or tension spring or a component made of an elastic material may be present.

In order that a force, for example that exerted by a drive, is transmitted efficiently to the main body to make the latter rotate in controlled fashion about the beam axis, in one advantageous embodiment of the invention a first drive track partially or completely encircling the main body is formed. The first drive track is either fixedly connected to the main body, fastened thereon such that the two are mechanically coupled, or formed on the surface of the main body. Such a drive track can be, for example, a toothed ring for engagement with a gearwheel or a toothed belt or a track suitably designed for a friction-wheel drive. In particular, a form-fitting drive prevents slippage between the drive input and drive output, and this in turn has a positive effect on the resolution of and the ability to position the assembly. Moreover, a form fit makes it easy to avoid inadvertent shifting of the main body and the holder relative to one another. Inadvertent shifting can also be avoided by a suitable design of a friction-wheel drive and/or by the use of a braking device. The setting of the required braking torque by means of the coordination of the frictional forces between the gear mechanism partners and the mountings thereof proves to be advantageous. Furthermore, additional components such as rotary brakes or latching devices can be present and used.

In this context, in a further embodiment of the device according to the invention, a second drive track for transmitting a force to the cam control and for making the latter revolve around the main body can be formed on a side surface, in particular facing away from the main body, of the cam control. The cam control can then be in contact, for example by means of one of its end faces, with the holder, or with the actuating lever.

The device according to the invention can be a constituent part of an arrangement. Part of the arrangement is a frame or a housing, in which the main body is rotatably mounted about the beam axis. The beam axis advantageously coincides with an optical axis of an optical beam path. Moreover, there is at least one drive for applying a (n actuating) force to the first drive track and/or to the second drive track.

In an advantageous embodiment of the invention, for both drive tracks there is a common drive. This makes it possible to omit a drive and take up less structural space. The common drive uses two gear mechanisms with mutually opposite drive directions and freewheeling directions to selectively, depending on the direction of rotation, conduct a force for rotating the main body and/or the cam control onto the corresponding components.

The drives that are present are connected, in a way suitable for exchanging data, to a controller, for example in the form of a computer, a microcontroller or an FPGA. The controller can optionally receive data from a sensor which is located in the beam path and can be used to detect and evaluate a current effect of the optical element on the radiation, for example its beam position. As an alternative or in addition, a current rotational position of the main body and/or of the holder, or of the cam control, can be detected and evaluated. Depending on the evaluation results, the controller can be used to give control commands to the drives, or to the common drive, which when executed cause a current rotational position of the main body and/or a current inclination of the holder and correspondingly of the optical element to be adjusted. Such a structure makes it possible to allow tracking of the beam and/or manipulation in ongoing scientific experiments, and this has a positive effect on necessary repetitions and the processing times.

The device according to the invention and the arrangement according to the invention can be present and used in an optical system, for example in an illumination detection device, for optical positioning tasks (by scanning) or zoom systems, e.g. in microscopes or other opto-mechanical systems.

The invention will be explained in greater detail below on the basis of exemplary embodiments and with reference to drawings, in which:

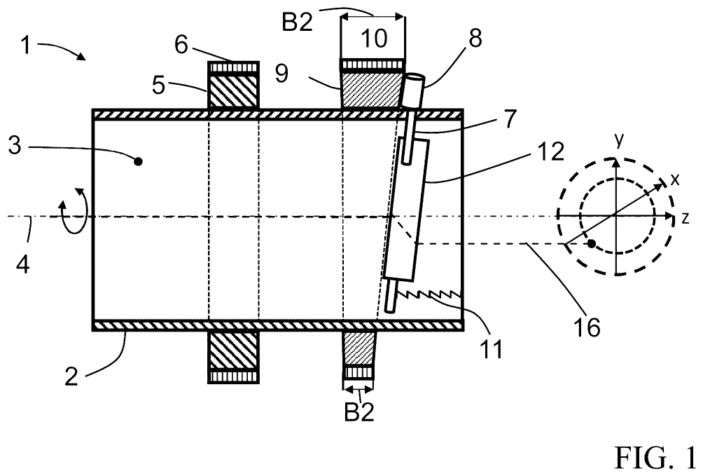

FIG. 1 shows a schematic illustration of an exemplary embodiment of a device according to the invention in a side view, in (longitudinal) section;

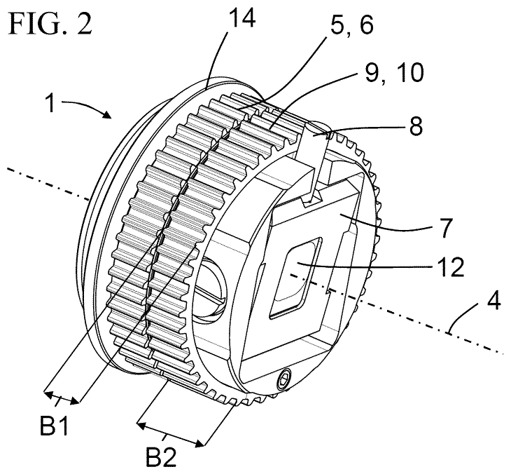

FIG. 2 shows a schematic illustration of the exemplary embodiment of the device according to the invention in a perspective view; and

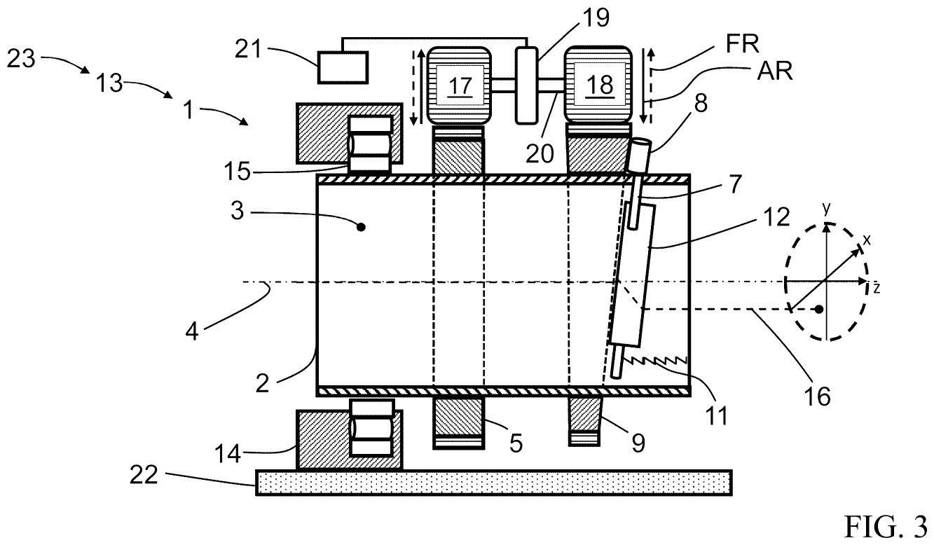

FIG. 3 shows a schematic illustration of an exemplary embodiment of an arrangement according to the invention in a side view, in (longitudinal) section.

In an illustration of a device 1 according to the invention, the essential parts shown are a main body 2 which has a beam passage 3 along a beam axis 4 and a holder 7 for holding an optical element 12 (FIG. 1).

The main body 2 can be rotated about the beam axis 4 by applying a force in particular to a drive sprocket 5 encircling the main body 2. The drive sprocket 5 is connected to the main body 2 or formed on its surface. A first drive track 6 in the form of a toothed ring is formed on an outwardly facing end face of the drive sprocket 5.

An actuating lever 8 of the holder 7 rests against a side face of a control cam (cam disc) of a cam control 9. In order to keep this contact constant, there is a spring element 11 which is connected to the main body 2 and the holder 7 and causes the actuating lever 8 to exert a contact pressure on the cam control 9.

The cam control 9 freely encircles the main body 2, and is thus freely rotatable about the main body 2. On its outer circumferential surface, the cam control 9 has a second drive track 10 in the form of a toothed ring. The width of the cam control 9 increases continuously from a minimum width B1 to a maximum width B2 and, continuing around the circumference, then decreases back to the minimum width B1. FIG. 1 shows a simplified view of the current position of the cam control 9, in which the maximum width B2 of the cam control 9 presses the actuating lever 8 outwards as far as possible and as a result the holder 7 and the optical element 12 can be inclined, to the maximum extent achievable with the selected cam control 9, with respect to the beam axis 4.

The mode of operation of the device 1 according to the invention is depicted on the basis of a virtual beam (optical beam path 16), which is directed along the beam axis 4 into the beam passage 3. The optical element 12 is a plane plate made of glass with two mutually plane-parallel side faces. When the beam is incident on the optical element 12, it is refracted towards the vertical in accordance with the law of refraction and passes through the optical element 12 at an angle. Owing to this oblique path through the optical element 12, the beam leaves the beam axis 4. When it reaches the second side face of the optical element 12, the beam is refracted again, this time away from the vertical, and leaves the optical element 12 offset from the beam axis 4. This radial offset of the beam in a y-direction is depicted on the right in the image by way of example by means of the coordinate system.

If the current inclination of the holder 7 is maintained and the main body 2 is rotated about the beam axis 4, the point of incidence of the beam is guided on a circular path (inner circle, dashed line). The outer circle, also illustrated by a dashed line, indicates by way of example the maximum area in which the beam can be directed with the possible combinations of the rotational position of the main body 2 and the inclination of the holder 7.

An embodiment of the first and the second drive track 6, 10 as respective toothed rings is shown in FIG. 2. The compact structure of the device 1 according to the invention can clearly be seen. In addition to the technical elements already described, there is a support 14, which holds the main body 2 and serves for connection to a frame or housing 22, in order to mount the device 1 in an optical system, for example in a microscope 23, and be able to operate it there (see also FIG. 3).

An exemplary embodiment of the invention as a constituent part of an arrangement 13 in a microscope 23 has a common drive 19, which makes it is possible to move both the main body 2 about the beam axis 4 and the cam control 9 about the main body 2.

In order that both movements can be performed independently of one another with just one common drive 19, between the common drive 19 and each of the elements 2, 9 that are to be driven there is a first gear mechanism 17 and a second gear mechanism 18.

The gear mechanisms 17, 18 can be driven by the action of the drive 19. A driveshaft 20 for transmitting force from the drive 19 to the gear mechanisms 17, 18 is illustrated by way of example. The first gear mechanism 17 is in contact with the first drive track 6 of the drive sprocket 5 so as to allow a force to be transmitted from the first gear mechanism 17 to the drive sprocket 5 and thus to the main body 2. The same correspondingly applies to the second gear mechanism 18 connected to the cam control 9. The drive 19 is advantageously a motor that can be actuated with regard to its respective direction of rotation, and the angular range respectively swept over in this case, by means of a controller 21.

Both gear mechanisms 17 and 18 are provided with a freewheel (freewheeling direction FR) in a direction of their mechanical force flow, while in the opposite direction force is guided from the common drive 19 to the relevant drive tracks 6, 10 (see FIGS. 1 and 2) (drive direction AR). Both directions are symbolized by arrows with different line types, besides the reference signs.

FIG. 3 shows a view of the respective encircling end sides of the gear mechanisms 17, 18, which are both in the form of gearwheels corresponding to the respective drive tracks 6, 10. On the basis of the control commands from the controller 21, the common drive 19 rotates in one direction by a certain angle of rotation. That gear mechanism 17, 18 whose drive direction AR corresponds to the current direction of rotation of the drive 19 conducts the force onto the relevant drive track 6, 10 and causes the main body 2, or the cam control 9, to rotate by an angle determined by the transmission ratio of the gear mechanism 17, 18.

If the drive 19 stops, or its direction of rotation is reversed, the previously driven gear mechanism 17, 18 operates in the freewheeling direction FR and no force is conveyed. When the direction of rotation changes, the respective other gear mechanism 17, 18 moves in the drive direction AR. In this way, only one drive 19 operating in succession is needed to adjust both a rotational position of the main body 2 and an inclination of the holder 7.

If, instead of a common drive 19 for the movement of the main body 2 and the adjustment of the inclination of the holder 7, respective separate drives (not shown) are used, the actuating movements can also be superposed and thus performed simultaneously.

The device 1 according to the invention is rotatably mounted and held by means of bearings 15, for example rolling bearings, in a support 14. The support 14 may in turn be arranged in a frame or a housing 22 (only indicated here), with the beam axis 4 advantageously coinciding with an optical beam path 16.

### REFERENCE SIGNS

1 Device
2 Main body
3 Beam passage
4 Beam axis
5 Drive sprocket
6 First drive track
7 Holder
8 Actuating lever
9 Cam control, cam disc
10 Second drive track
11 Spring element
12 Optical element
13 Arrangement
14 Support
15 Bearing
16 Optical beam path
17 First gear mechanism
18 Second gear mechanism
19 Common drive
20 Driveshaft
21 Controller
22 Housing
23 Microscope
AR Drive direction
B1 Minimum width
B2 Maximum width
FR Freewheeling direction

1. A device for aligning an optical element in an optical beam path, the device comprising:
a main body which has a free beam passage along a beam axis, wherein the main body is configured to be rotated about the beam axis;
a holder for holding the optical element on the beam axis, wherein
the holder is configured to be inclined in controlled fashion relative to the beam axis by an angle selected from a predetermined angular range in that by a cam control, which partially or completely encircles the main body and is decoupled from a rotational position of the main body, a current inclination of the holder is configured to be adjusted.

2. The device according to claim 1, wherein a first drive track partially or completely encircling the main body is designed to transmit a force to the main body and make the latter rotate about the beam axis.

3. The device according to claim 1, wherein a second drive track for transmitting a force to the cam control and for making the latter revolve around the main body is formed on a side surface of the cam control.

4. The device according to claim 1, wherein the optical element provided is a plane plate which is transparent to a selected wavelength range.

5. An arrangement, comprising:
a device according to claim 1, and
a housing, in which the main body is rotatably mounted about the beam axis,
and at least one drive for applying a force to the first drive track and/or to the second drive track.

6. The arrangement according to claim 5, wherein, for the first drive track and the second drive track, there is a common drive which uses two gear mechanisms with mutually opposite drive directions (AR) and freewheeling directions (FR) to selectively, depending on the direction of rotation, introduce a force for rotating the main body and/or the cam control.

7. A microscope, comprising:
the arrangement according to claim 5.
